(19) United States
(12) Patent Application Publication
(10) Pub. No.: US 2006/0294503 A1
(43) Pub. Date: Dec. 28, 2006

(54) Code coverage analysis

(75) Inventors: Jason Todd Henderson, Tacoma, WA (US); Manish Garg, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/166,864

(22) Filed: Jun. 24, 2005

(51) Int. Cl. G06F 9/44

(52) U.S. Cl. 717/131

(57) ABSTRACT

Code coverage analysis for uncompiled code, such as scripts, is performed by instrumenting the scripts with log statements, executing the scripts, and analyzing the scripts. The log statements are appended to discrete blocks of the scripts during the instrumenting and are executed when the corresponding scripts are executed. The log statements cause logs to be written to a log file when the corresponding blocks are executed. The log file is subsequently compared to the original scripts to determine what portion and percentages of the code have been executed. Code coverage data is presented in a variety of formats to the user.

### CROSS-REFERENCE TO RELATED APPLICATIONS

Not applicable.

### BACKGROUND OF THE INVENTION

Software testing is fast emerging as a specialty area with increased attention on test specific tools and methodologies. Code coverage analysis, for example, is one such methodology. Code coverage analysis is the discovery of instructions in a software program that have been executed during a test run and the discovery of how the testing can be further enhanced to cover or execute more of the instructions in the software program during subsequent testing.

Code coverage analysis is important for developers and software vendors to validate the functionality of their software and to find potential problems prior to distributing the software to the end user. Accordingly, for at least this reason, it is important to test as much of the code in a program as possible, to make sure it is all working. Code coverage analysis can also be helpful in finding dormant or dead code that was once considered useful, but no longer is necessary. When unnecessary code is discovered, it can be removed from the software, thereby reducing the memory requirements for storing the program and freeing up space for other useful information.

One known toolset for performing software testing, including code coverage analysis, is the Magellan toolset created by Microsoft. The Magellan toolset has proven useful, for example, for obtaining code coverage data for unmanaged (C++), managed (C#) and other compiled software codes.

The Magellan toolset generally works by instrumenting or writing assembly level code into object files of output source code, such as DLL and EXE type object files. The data written to the output can help identify portions of the code that are executed during a test run of the compiled code.

The Magellan toolset does not, however, presently provide any solution for obtaining code coverage data for uncompiled software, such as script files. In fact, no known software testing application is known to provide a good solution for obtaining code coverage data for script files and other uncompiled software.

One reason code coverage analysis software for uncompiled code, such as scripts, has been slow to develop is that scripts present unique challenges, as compared to compiled code. JScript, for example, unlike compiled code, uses a browser host, such that it cannot be independently accessed and executed for testing by the client. In particular, a client can independently access or download compiled code to initiate virtually any of the instructions in the compiled code. However, with a JScript, the client is only provided indirect access through the context of their browser. Accordingly, in order to execute a JScript, a client browser must access the JScript and execute the script in a browser context, such that the client and testing software cannot independently access and test the JScript.

### BRIEF SUMMARY OF THE INVENTION

The present invention is directed to systems, methods and computer program products for performing and providing code coverage analysis and, even more particularly, for performing and providing code coverage analysis for uncompiled code such as scripts.

According to some embodiments, code coverage data is collected or otherwise obtained for uncompiled code containing scripts by implementing a method that includes instrumenting the scripts with log statements, which track the execution of blocks or other portions of the code during testing.

According to some embodiments, the methods for instrumenting the scripts includes parsing the scripts to identify separate and defined blocks of code within the scripts. Log statements are then appended to the end of each identified block for which code coverage analysis is to be performed.

During testing and execution of a program, the uncompiled code, log statements and corresponding scripts are executed and corresponding code coverage data is obtained, which can be reflected in a variety of outputs and user interfaces. The log statements, which are executed when the corresponding script blocks are executed, write corresponding data regarding the execution of the script blocks into an execution log file.

During subsequent analysis, the execution log file is then compared against the original scripts in the program to calculate the total percentage of blocks in the program that were executed.

According to some alternative embodiments, code coverage analysis can also include collecting and reporting data regarding execution of one or more specific lines, arcs or other segments in the code.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates one embodiment of code that includes a plurality of definable blocks and arcs;

FIG. 2 illustrates a flowchart of one embodiment of a method for obtaining code coverage data;

FIG. 3 illustrates a screenshot of one embodiment of a user interface for providing code coverage analysis;

FIG. 4 illustrates another screenshot of an embodiment of a user interface for providing code coverage analysis; and

FIG. 5 illustrates a block diagram of one embodiment of a computing environment that may be used to implement certain the features of the present invention.

### DETAILED DESCRIPTION OF THE PREFERRED EMBODIMENTS

The principles of the present invention relate to code coverage analysis and, in particular, for collecting and providing code coverage data for uncompiled code, such as scripts.

According to some embodiments of the invention, code coverage analysis is performed by identifying scripts within a program, instrumenting the scripts, executing the scripts, and performing analysis of the executed scripts.

Instrumenting the scripts and analyzing the executed scripts can be performed on a block by block basis. Code coverage analysis according to the invention can also be performed on a line by line basis or any other basis to identify specific lines, arcs, or any other definable segment or portion of code that is executed during a test run.

To help provide context for interpreting the claim language and some of the terminology used in the following description, a few definitions will now be provided.

“Uncompiled code” refers to a grouping of computer-executable instructions, prior to be compiled. Uncompiled code can include scripts or script files, which comprises a file having one or more scripts. A lot of uncompiled code, such as scripts, is not independently accessible by a client system, and cannot, therefore, be executed outside of a browser context. It will be appreciated, however, that the ability of a client system to independently access a segment of code should not be construed as indicating the code segment is compiled. Some shell scripts, for example, are uncompiled but can still provide some independent access.

The term “script”, as used herein, refers to a list of commands or instructions written in a scripting language. Script languages include, but are not limited to JScript (JavaScript), Visual Basic (VB), Shell scripts, such as TCL/Tk, Perl, Python, Windows/UNIX shell scripting, and so forth.

The term “block” is defined as a set of contiguous instructions (computer-executable code) that has exactly one entry point and one exit point. Calls, jumps, and branches mark the end of a block. Branches often, although, not necessarily, include conditional statements (such as, like if, then, else switch, break, continue, do . . . while, for, return, while, and so forth). A block typically consists of multiple lines of computer-executable instructions. According to some alternative embodiments a block can consist of a single line or a single computer-executable instruction.

The term “arc” refers to the execution paths between blocks. Accordingly, an arc typically identifies the corresponding blocks that call an entry point of a block and the blocks that are called by an exit point of the block.

An example will now be provided to further illustrate the different components defined above.

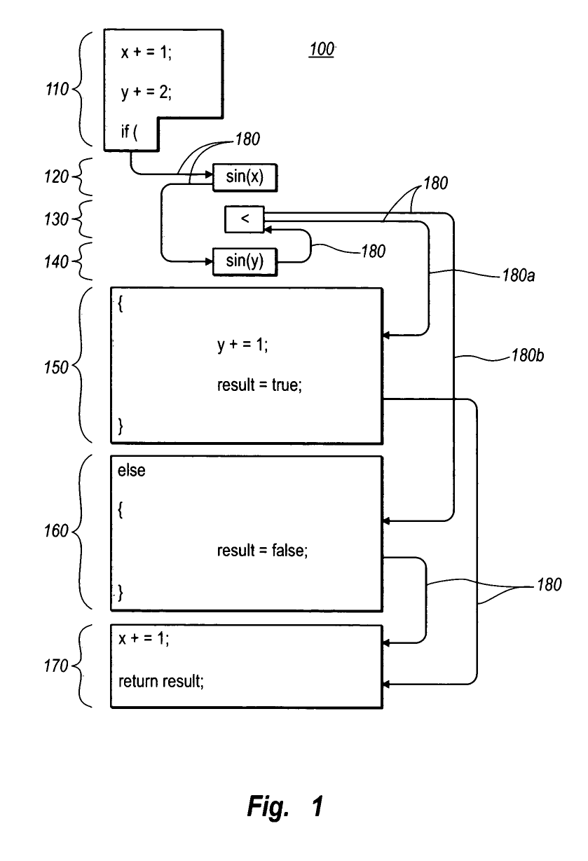

FIG. 1 illustrates one embodiment of code having a plurality of definable blocks and arcs. For example, the code 100 shown in FIG. 1 includes blocks 110, 120, 130, 140, 150, 160, 170. The illustrated code 100 also includes a plurality of different arcs 180. Different arcs 180 can define different execution paths. For example, one arc 180(a) is shown as extending directly between block 130 and block 150, whereas a separate arc 180(b) is shown as extending directly between block 130 and block 160. Accordingly, this indicates that during execution of the code 100, that block 150 and block 160 may be alternatives, and such that they may not both be executed during a particular implementation of the code 100.

To help provide a thorough code coverage analysis of compiled code during testing, different techniques can be used. For example, Magellan software developed by Microsoft can provide thorough code coverage analysis of compiled code.

However, no known software tools have thus far been developed to provide thorough and efficient code coverage analysis of uncompiled code, such as scripts. The present invention overcomes this problem by providing a new and unique method for performing code coverage analysis of uncompiled code.

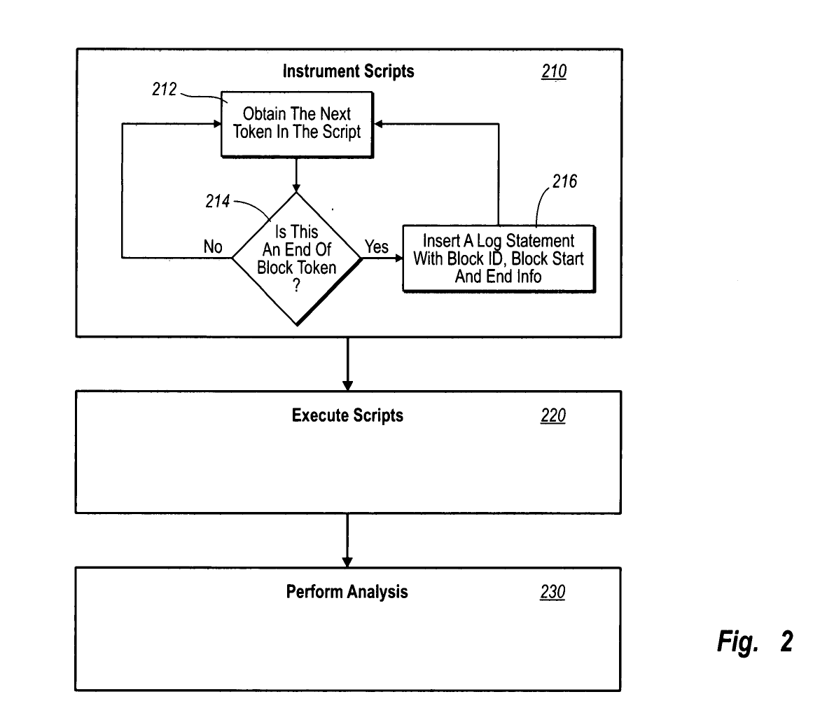

FIG. 2 illustrates a flowchart 200 of one embodiment of a method according to the present invention for performing code coverage analysis. As shown, the flowchart 200 includes instrumenting scripts (210), executing the scripts (220), and performing an analysis (230), each of which will now be described in more detail.

Instrumenting of the scripts (210), essentially comprises the writing of log statements to discrete blocks or other defined portions of the scripts. These log statements, which are subsequently executed when the corresponding script blocks are executed, write execution data to one or more log files that are subsequently analyzed to determine which blocks or other portions of the scripts have been executed.

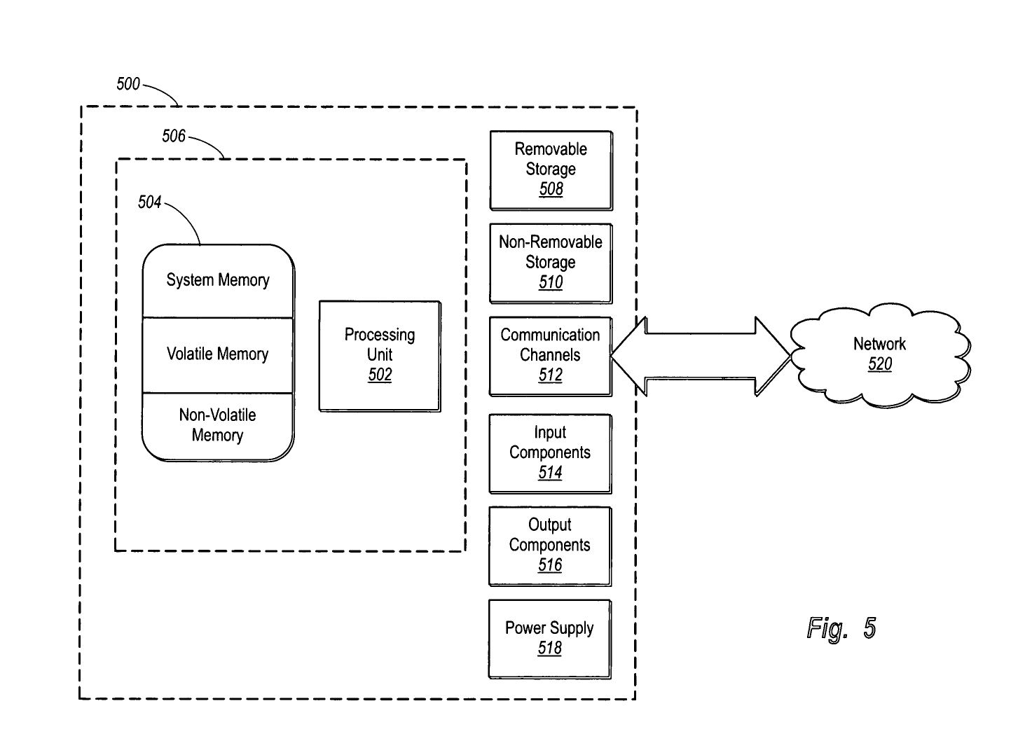

With regard to the log file, it will be appreciated that the log file can actually include one or more log files. A computing system, such as the one described below in reference to FIG. 5, access the log file(s) from a local memory or from a remote memory location over a network connection.

With regard to instrumenting the scripts, it will be appreciated that this step can also include corresponding acts, for identifying and accessing the scripts in one or more files that are available to the computing system, either locally or remotely, and for which testing is to be performed.

In some embodiments, after the scripts are identified, the script(s) within a program are parsed and tokenized to identify the different components or elements of each script. In some embodiments, the scripts are parsed to identify the blocks of the scripts. Because a block can be defined in a variety of different ways, the actual methodology used to perform identification of the various blocks in the script, will vary depending on the type of scripting language used and the definition the user is using to define a block.

It will also be appreciated that there are many different parsing techniques that can be used to parse a script and to identify the blocks of the script. According to one embodiment, a two-pass ad-hoc parser is used. This parser tokenizes the scripts in a first pass according to defined language tokens. Language tokens can be specified, for example, in a language specification such as, but not limited to, the Baukus-Naur Form (BNF) language specification and the Augmented BNF (ABNF) specification, which are both well-known in the art.

During parsing, and instrumenting of the scripts (210), the tokens identified during the first pass are obtained (212) and inspected to determine whether said tokens are block ending (214). If they are, then a log statement is written to the corresponding block, including a block id, block start information and block end information, as well as any other information that can be used to define the block (216). If a token is not determined to be an end of a block, then the next token is retrieved (212).

By proceeding in the forgoing manner, log statements will be appended to the blocks in the program. Appending the log statement to the end of the block can be helpful to ensure the block is executed before log information is written to the log file. However, it will be appreciated, that it is not absolutely necessary for the log statement to be end of the block. For example, in alternative embodiments, a log statement that adequately defines the block can be inserted at a different location of the block than at the end, as long as the log statement is provided with enough to define the block and with adequate instructions to control the writing of the log information after the block is executed or at any other predetermined or desired time.

By proceeding in the foregoing manner, and as illustrated in acts 212, 214 and 216 of FIG. 2, it is likely that log statements will be written to each of the blocks in a script, code segment or program being analyzed. In this regard, it should also be appreciated that it is not necessary for each block to have a log statement written to it. In some embodiments, for example, it may be desired to only write log statements for one or more known blocks within a script or a program.

Some non-limiting examples of how scripts can be instrumented with log statements will now be provided with regard to a code segment comprising VBScripts.

The following code segment comprises seventeen lines of an unistrumented VBScript segment:

| | |
|---|---|
| 1 | ′ ******************************* |
| 2 | ′ * |
| 3 | ′ * Simple VBScript Code |
| 4 | Dim String |
| 5 | String = “General String” |
| 6 | Call test_func( ) |
| 7 | |
| 8 | Dim var1 |
| 9 | Set var1 = WScript.CreateObject(“Excel.Application”) |
| 10 | var1.Visible = TRUE |
| 11 | Dim var3 = 5 |
| 12 | Sub test_func( ) |
| 13 | var2 = 1 |
| 14 | |
| 15 | If var2 = 2 Then |

| | |
|---|---|
| 16 | WScript.Quit |

| | |
|---|---|
| 17 | End If |

The forgoing VBScript segment is also shown below, with the same corresponding seventeen lines of code. However, this time the VBScript segment is shown with newly inserted log statements, such as, for example, after the VBScript has been instrumented according to one embodiment of the invention:

| 1 | ′ ******************************* |
|---|---|
| 2 | ′ * |
| 3 | ′ * Simple VBScript Code |
| 4 | Dim String |
| 5 | String = ″General String″ |
| | Call Log(“script.vbs::1-5-5”) |
| 6 | Call test_func( ) |
| | Call Log(“script.js::2-6-6”) |
| 7 | |
| 8 | Dim var1 |
| | Call Log(“script.js::3-8-9:10”) |
| 9 | Set var1 = WScript.CreateObject(″Excel.Application″) |
| | Call Log(“script.js::4-9:11-9”) |
| 10 | var1.Visible = TRUE |
| 11 | Dim var3 = 5 |
| | Call Log(“script.js::5-10-11”) |
| 12 | Sub test_func( ) |

| | |
|---|---|
| 13 | var2 = 1 |
| 14 | |

| | Call Log(“script.js::6-12-15”) |
|---|---|
| 15 | If var2 = 2 Then |

| | |
|---|---|
| 16 | WScript.Quit |

| | Call Log(“script.js::7-16-17”) |
|---|---|
| 17 | End If |

As shown, during this implementation, it was determined that lines 5, 6, 8, 9, 11 13, and 16 comprised tokens that were block ending, such that a log statement was appended to each corresponding block, following the block ending token, and including the corresponding block id, block start and end information.

It will be appreciated, however, that different scripting languages have different characteristics. In VBScript, for example, a logical end of statement is be conveyed by a new line character. In other scripting languages, however, like JScript the semi-colon character is used to convey the end of a statement. Accordingly, the instrumentation techniques used to apply the log statements can vary significantly. As a result, the Log statements in Jscript can be placed on the same line as another statement following a semi-colon. In VBscript, however, each log statement is typically written on a new line.

In the VBscript code example, above, the log statement following line 5 includes a call to the log for script.vbs. This causes log information to be written to the script.vbs log file when the corresponding block and log statement are executed. The log information written to the log file can include the block id, block start and end information, as well as any other information specified.

The log statements include block information, which can be presented in different formats. In one embodiment, the log statement includes the script name, followed by a block number, followed by a block start identifier, followed by a block end identifier.

The block start and block end identifiers can also have different formats. In one embodiment the block start identifier includes a start line followed by a colon followed by a start character. The block end identifier can also have a corresponding end line followed by a colon followed by an end character. In another embodiment, the block start identifier consists of a start line and the block end identifier consists of an end line.

In the present example, for instance, the block is identified as block 1, beginning and ending on line 5.

As another example, the log statement following line 11 corresponds to block 5, which begins on line 10 and ends on line 11. This log statement is different than the log statement corresponding to block 1 because it corresponds to a different block and because it makes a call to a different log using the reference script.js instead of script.vbs.

In another example, the log statement corresponding to block 3, following line 8, has a begins on line 8 and ends on line 9, character 10, such that it includes “Set Var1=”.

In another example, the log statement corresponding to block 4, following line 9, begins on line 9 and ends on line 11, character 9.

The foregoing examples have been provided to illustrate that there are different formats and techniques that can be used to instrument the scripts with different log statements. The foregoing examples, however, are merely illustrative and should not, therefore, be construed as limiting the scope of the invention.

In view of the foregoing, it would also be good to revisit the definition of the term ‘block,’ which generally corresponds to a plurality of different lines of code or computer-executable instructions in a program or script. See, for example, block 6, corresponding to lines 12-15, above, and block 7, corresponding to lines 16 and 17. One interesting note is that a log statement can sometimes be placed before the end of the block. For example, block 6 has a log statement preceding line 15, which is the end of the block. In many instances, however, the log statement is appended to the end of the corresponding block.

Although the foregoing examples illustrate how a block can include many different lines, the invention is not so limited. In fact, in some embodiments, a block corresponds to only a single line of code. See, for example, block 6, corresponding to only line 6. In yet other embodiments, a block corresponds to a portion of a line of code, alone or in combination with one or more other portions or lines of code. (not shown in the foregoing code).

Although blocks are defined above as also typically corresponding to conditional statements, this is not necessarily true. Accordingly, some additional non-limiting examples of blocks will now be provided to help illustrate the variety of different types and formats in which blocks can be defined.

The following examples correspond to JScript code segments, whereas the foregoing examples corresponded to VBScript code segments. It will be appreciated, however, that the present invention can be utilized with other types of scripting languages and uncompiled code as well. Accordingly, the following series of examples is merely illustrative, and not, exhaustive and does not, therefore, limit the scope of the invention.

The following examples will be provided in reference to line numbers 1-62, to facilitate quick reference between the lines of code before and after being instrumented. It will be appreciated, however, that the actual numeric values assigned to the following lines of code are insignificant.

Here is one example of several contiguous lines of source code forming a block.

1 // Global code
2 var VAR1 = ″value″;
3 var VAR1 = “value2”;

Here is the same block after being instrumented.

1 // Global code
2 var VAR1 = ″value″;
3 var VAR1 = “value2”; Log(“script.js::1-1:1-3:20”);

In some embodiments, function calls are treated as a block of their own. Accordingly, a function call ends a previous block. The end of a function call also marks the start of a new block. Here is an example illustrating this, wherein lines 4, 5 and 6 each represent their own blocks.

4 VAR1 = 1;
5 function(“param”);
6 VAR1 = 2;

Here are the same lines/blocks following instrumentation:

4 VAR1 = 1; Log(“script.js::2-4:1-4:9”);
5 function(“param”); Log(“script.js::3-5:1-5:18”);
6 VAR1 = 2; Log(“script.js::4-6:1-6:9”);

In some embodiments, a function is also treated as its own block, as shown by this example.

7 function f1(args)
8 {
9

}

Here is an example of a conditional “if” block that marks the end of a block. In this example, line 10 is one block and lines 11-13 are a separate block.

10 if (cond)
11 {
12 stmt;
13 }

Here are the same blocks after being instrumented.

| 10 if (cond && Log(“script.js::5-7:1-10:13”)) | |
|---|---|
| 11 { | |
| 12 | stmt; |

13 Log(“script.js::6-11:1-13:1”);}

Here is an example of an “else” conditional block.

14 else
15 {
16 stmt;
17 }

Here is the same “else” block after being instrumented.

| 14 else | |
|---|---|
| 15 { | |
| 16 | stmt; |

17 Log(“script.js::7-14:1-17:1”);}

Here is an example of code with a “Do . . . While” conditional block. As shown, lines 18-21 comprise one block and line 22 comprises a separate block.

| 18 do | |
|---|---|
| 19 { | |
| 20 | stmt; |
| 21 } | |

22 while (condition)

Here are the same blocks after being instrumented.

| 18 do | |
|---|---|
| 19 { | |
| 20 | stmt; |

21 Log(“script.js::8-18:1-21:1”);}
22 while (condition && Log(“script.js::9-22:1-22:20”);)

Here is an example of code with three separate blocks. The middle block is defined by a condition within a “for” loop. In particular, the text “; i<100;” defines a block that is separate from the rest of the code.

| 24 for (var i=0; i<100; i++) | |
|---|---|
| 25 { | |
| 26 | stmt; |
| 27 } | |

Accordingly, here is the same code after being instrumented.

24 for (var i=0 && Log(“script.js::10-24:1-24:15”); i<100 &&
Log(“script.js::11-24:16-24:23”); i++)
25 {

| | |
|---|---|
| 26 | stmt; |

27 Log(“script.js::12-24:24-27:1”);}

In the following example of code, which includes a “switch” condition, the “break;”, “Continue”, and “Return” statements mark the end of a current block and the “Labeled” statement marks the continuation of a block.

| 29 switch (condition) | |
|---|---|
| 30 { | |
| 31 | case CASE1: |

| | |
|---|---|
| 32 | stmt; |
| 33 | break; |

| | |
|---|---|
| 34 | case CASE2: |

| 35 LABEL1: stmt; | |
|---|---|
| 36 | continue; |

| | |
|---|---|
| 37 | default: |

| | |
|---|---|
| 38 | stmt; |
| 39 | return; |
| 40 } | |

Here is the same code after being instrumented.

| 29 switch (condition) | |
|---|---|
| 30 {Log(“script.js::13-29:1-30:1”); | |
| 31 | case CASE1: |

| | |
|---|---|
| 32 | stmt; |
| 33 | Log(“script.js::14-31:1-33:6”);break; |

| | |
|---|---|
| 34 | case CASE2: |

| 35 LABEL1: stmt; | |
|---|---|
| 36 | Log(“script.js::15-34:1-36:9”);continue; |

| | |
|---|---|
| 37 | default: |

| | |
|---|---|
| 38 | stmt; |
| 39 | Log(“script.js::16-37:1-39:7”);return; |
| 40 } | |

Here is an example of code with a “while” condition.

| 42 while(condition) | |
|---|---|
| 43 { | |
| 44 | stmt; |
| 45 } | |

Here is the same code after being instrumented.

| 42 while(condition && Log(“script.js::17-42:1-42:15”);) | |
|---|---|
| 43 { | |
| 44 | stmt; |

45 Log(“script.js::18-43:1-45:1”);}

Here is an example of code with non-conditional “catch” “try” and “finally” blocks/elements.

51 try
52 {
53 ...
54 }
55 catch (e)
56 {
57 ...
58 }
59 finally
60 {
61 ...
62 }

Here is the same code after being instrumented.

51 try
52 {
53 ...
54 Log(“script.js::19-51:1-54:1”);}
55 catch (e)
56 {
57 ...
58 Log(“script.js::20-55:1-58:1”);}
59 finally
60 {
61 ...
62 Log(“script.js::21-59:1-62:1”);}

According to some embodiments, all other statements, other than those identified above, mark the continuation of a current block, except for comments, which are not included as part of any block. In alternative embodiments, other block definitions are used.

Attention will now be redirected to the flowchart 200 that is shown in FIG. 2. As shown, the method includes executing the scripts after they have been scripted (220). The act of executing the scripts is essentially the second phase of performing code coverage analysis. Each time a block in the script gets executed, the corresponding log statement for that block gets executed, and such that the corresponding log information is written to one or more corresponding log files.

The scripts can be executed by using software of the invention for accessing and launching the scripts. Even if the scripts are launched within a browser context, however, they are still able to provide the critical code coverage data because the log statements are written to the scripts themselves, as described above, and such that the log statements write the corresponding log information to the log file(s) during execution.

Finally, code coverage analysis is performed (230), by analyzing the execution logs in the log file(s) against the original scripts and log statements. The output of the analysis can include a variety of different information that is presented in a variety of different formats. Some non-limiting examples of output that can be obtained from the code coverage analysis include, blocks of code that have executed, blocks of code that have not executed, percentages of blocks executed, percentages of blocks that have not executed, arcs covered (this can be extrapolated by determining which blocks were executed), arcs not covered (this can be extrapolated by determining which blocks were not executed), percentage of arcs covered, percentage of arcs not covered, and so forth. The output of the analysis can also be presented in varying levels of detail and granularity.

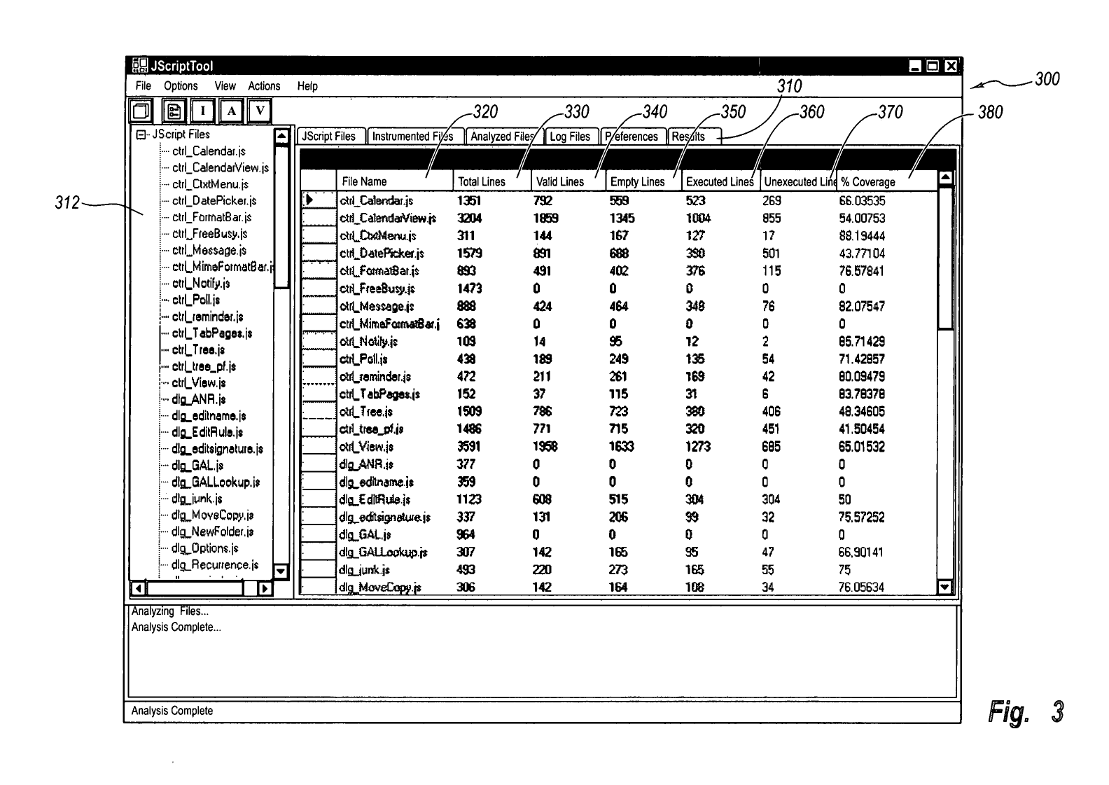

According to some embodiments, a user interface is provided to identify programs or scripts to be analyzed. For example, the user interface 300 shown in FIG. 3 can be used with a plurality of different menu options to view results of a test, for example, as well as a variety of different information corresponding to the list of script files identified in window 312.

As shown in FIG. 3, the results of one test, which are reflected in response to selecting the results menu option 310, are shown in a spreadsheet layout that includes a plurality of script files shown in a first column 320 and a plurality of other columns reflecting analysis data corresponding to each file. For example, a total lines column 330) reflects to a total number lines tested for each file, column (340) reflects a total number of valid lines found (340) for each file, column (350) reflects a total number of empty lines for each file, column (360) reflects a total number of executed lines for each file, column (370) reflects a total number of unexecuted lines for each file, and column (380) reflects a total percentage of code coverage for each file, as defined as a percentage of the valid lines executed as compared to the total valid lines in each file (column 360/column 340).

Despite the foregoing example of calculating the code coverage percentage, it will be appreciated that different calculations of code coverage percentages can also be used to accommodate different needs and preferences.

Similarly, different user interfaces can also be provided to provide the same or different information with different layouts. In view of this, it is not necessary to describe every aspect of the presently illustrated user interface in any great detail. However, one additional screenshot will be shown to help provide context with regard to some of the different types of information that can be provided.

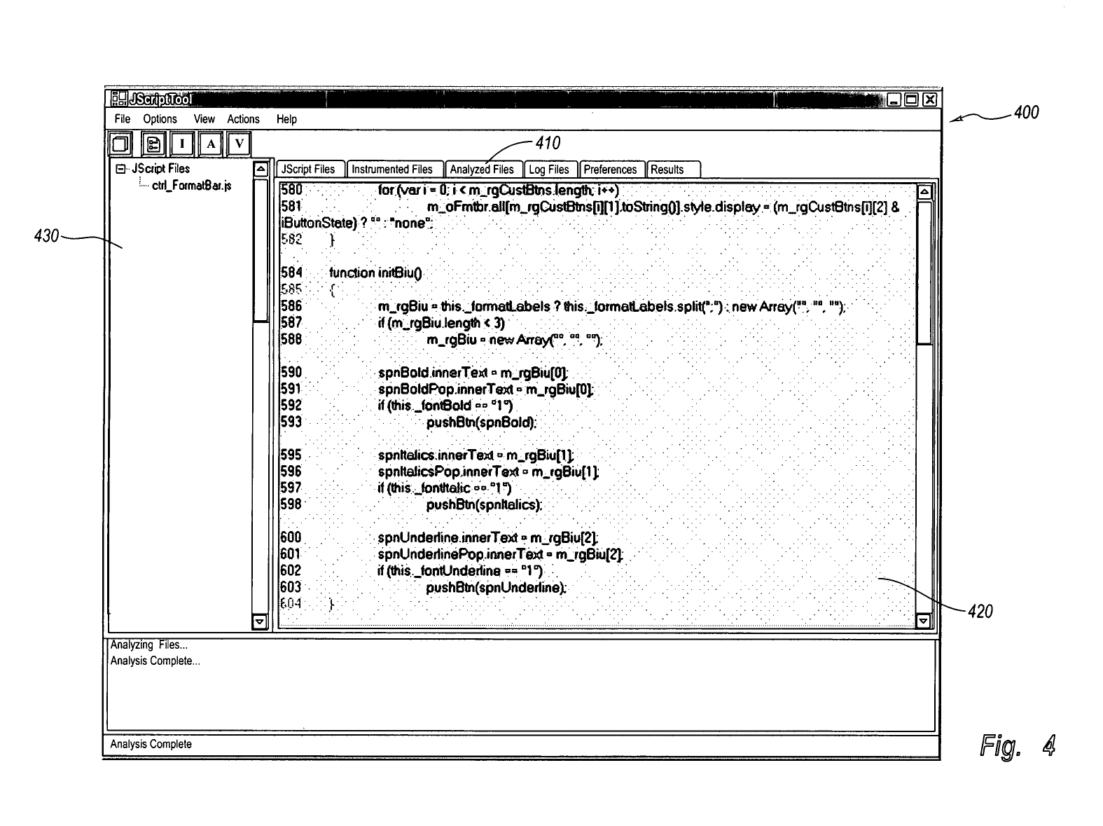

FIG. 4, for example, shows an embodiment of a user interface 400 with several menu options, including an analyzed files menu option 410. The user interface 400 also includes a window 420 that shows the code that has been analyzed and that corresponds to a file shown in the opposing window 430. This can be helpful for the tester to see what is actually being analyzed.

Other menu options can also let a user view the files prior to being instrumented as well as after being instrumented, or to view a corresponding log file that is created during the analysis process. Preferences and other information can also be accessed and displayed by the user interface.

In summary, the present invention provides methods and systems for performing code coverage analysis, particularly for uncompiled code, such as scripts. The scope of the invention also includes providing or presenting the results of the code coverage analysis, such as, for example, through one or more user interfaces. Although software such as Magellan is known to perform software analysis and code coverage analysis for compiled code, there have been no known software tools for providing code coverage analysis for uncompiled code, such as scripts prior to this invention.

The invention is not limited to any particular computing environment, although one is provided below. Accordingly, it will be appreciated that the invention can extend to embodiments in which code stored locally at a computing system is tested by that computing system, as well as to embodiments in which code stored remotely from the computing system is accessed and tested remotely.

Computing Environment

Inasmuch as the foregoing methods and descriptions have been described in reference to acts and symbolic representations of operations that are performed, it will be appreciated that the foregoing methods and acts are performed by one or more computers, unless indicated otherwise. As such, it will be understood that such acts and operations, which are computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while the principles of the invention are being described in the foregoing context, it is not meant to be limiting as those of skill in the art will appreciate that several of the acts and operations described hereinafter may also be implemented in hardware.

FIG. 5 shows a schematic diagram of one example computer architecture usable for such computing devices. For descriptive purposes, the architecture portrayed is only one example of a suitable environment and is not intended to suggest any limitation as to the scope of use or functionality of the invention. Neither should the computing systems be interpreted as having any dependency or requirement relating to any one or combination of components illustrated in FIG. 5.

The principles of the present invention are operational with numerous other general-purpose or special-purpose computing or communications environments or configurations. Examples of well known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

In its most basic configuration, a computing system 500 typically includes at least one processing unit 502 and memory 504. The memory 504 may be volatile (such as RAM), non-volatile (such as ROM, flash memory, etc.), or some combination of the two. This most basic configuration is illustrated in FIG. 5 by the dashed line 506.

The storage media devices may have additional features and functionality. For example, they may include additional storage (removable and non-removable) including, but not limited to, PCMCIA cards, magnetic and optical disks, and magnetic tape. Such additional storage is illustrated in FIG. 5 by removable storage 508 and non-removable storage 510. Computer-storage media include volatile and non-volatile, removable and non-removable media implemented in any method or technology for storage of information such as computer-readable instructions, data structures, program modules, or other data. Memory 504, removable storage 508, and non-removable storage 510 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computing system.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in software and hardware or hardware are also possible and contemplated.

Computing system 500 may also contain communication channels 512 that allow the host to communicate with other systems and devices over, for example, network 520. Although the network 520 may include any network type (whether now existing or to be developed in the future), examples include Token Ring, Ethernet, Bluetooth, 802.11, USB, 1394, SMS, SOAP over IP, or the like. Communication channels 512 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

The computing system 500 may also have input components 514 such as a keyboard, mouse, pen, a voice-input component, a touch-input device, and so forth. Output components 516 include screen displays, speakers, printer, etc., and rendering modules (often called “adapters”) for driving them. The computing system 500 has a power supply 518. All these components are well known in the art and need not be discussed at length here.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for providing code coverage analysis of uncompiled code that includes at least one script, the method comprising:
instrumenting a script of the uncompiled code by identifying one or more definable blocks of the script, and writing a log statement to the uncompiled code and that corresponds to the one or more definable blocks of the script;
executing the instrumented script; and
performing analysis of one or more execution logs generated during execution of the intrumented script to determine a portion of the uncompiled code that was executed.

2. A method as recited in claim 1, wherein executing the instrumented script includes executing the log statement when the corresponding one or more definable blocks of the script is executed.

3. A method as recited in claim 2, wherein executing the log statement causes the log statement to write log information corresponding to the one or more definable blocks to a log file.

4. A method as recited in claim 3, wherein the log file is compared to the uncompiled code to perform the analysis.

5. A method as recited in claim 1, wherein the one or more definable blocks includes a plurality of blocks.

6. A method as recited in claim 5, wherein instrumenting the script includes writing a separate log statement for each of the plurality of blocks.

7. A method as recited in claim 1, wherein each log statement provides a block identifier, a block beginning point and a block ending point.

8. A method as recited in claim 1, wherein performing analysis of the executed script includes determining which of one or more arcs were covered during execution of the script.

9. A method as recited in claim 1, wherein instrumenting the script includes appending the log statement to an end of the script.

10. A computer program product for use in a system implementing method for providing code coverage analysis of uncompiled code that includes at least one script, the computer program product comprising one or more computer-readable media having computer-executable instructions for implementing the method, wherein the method comprises:
instrumenting a script of the uncompiled code by identifying one or more definable blocks of the script, and writing a log statement to the uncompiled code and that corresponds to the one or more definable blocks of the script;
executing the instrumented script; and
performing analysis of one or more execution logs generated during execution of the intrumented script to determine a portion of the uncompiled code that was executed.

11. A computer program product as recited in claim 10, wherein the one or more definable blocks of the script are defined at least in part by a function call, and wherein each function call in the one or more definable blocks of the script defines a separate block.

12. A computer program product as recited in claim 10, wherein the one or more definable blocks of the script are defined at least in part by a condition in a for loop.

13. A computer program product as recited in claim 10, wherein the one or more definable blocks of the script are defined at least in part by a do . . . while condition.

14. A computer program product as recited in claim 10, wherein the one or more definable blocks of the script are defined at least in part by a break, continue or return statement, and wherein each of said break, continue and return statements, if present, define an end of block.

15. A computer program product as recited in claim 10, wherein the one or more definable blocks of the script include a plurality of continuous lines of source code.

16. A computer program product as recited in claim 10, wherein the script is a VBScript.

17. A computer program product as recited in claim 10, wherein the script is a JScript.

18. A computer program product as recited in claim 10, wherein the one or more computer readable media are one or more physical media.

19. A user interface for presenting results of code coverage analysis performed on uncompiled code that includes at least one script, wherein the user interface comprises:
a selectable option for viewing an instrumented version of the at least one script file, wherein the instrumented version is created by instrumenting at least one script of the uncompiled code after identifying one or more definable blocks of the script, and writing a log statement to the uncompiled code and that corresponds to the one or more definable blocks of the script; and
a selectable option for viewing results indicating portions of the uncompiled code that were executed during testing of at least the instrumented script and that were analyzed to determine the portion of the uncompiled code that were executed.

20. A user interface as recited in claim 19, further including a selectable option to view a log file corresponding to the executed portions of the uncompiled code.
